(19) United States
(12) Patent Application Publication
(10) Pub. No.: US 2022/0223330 A1
(43) Pub. Date: Jul. 14, 2022

(54) TECHNOLOGIES FOR A LOW-NOISE-GENERATING INDUCTOR

(71) Applicants: Long Wang, El Dorado Hills, CA (US); Ranjul Balakrishnan, Bangalore (IN); Sagar Dubey, Bangalore (IN); Stephen Hall, Middleton, ID (US); Srinivasan Rajagopalan, Palo Alto, CA (US)

(72) Inventors: Long Wang, El Dorado Hills, CA (US); Ranjul Balakrishnan, Bangalore (IN); Sagar Dubey, Bangalore (IN); Stephen Hall, Middleton, ID (US); Srinivasan Rajagopalan, Palo Alto, CA (US)

(21) Appl. No.: 17/711,113

(22) Filed: Apr. 1, 2022

(51) Int. Cl. H01F 27/06; H01F 27/24; H01F 27/28

(52) U.S. Cl. CPC H01F 27/06; H01F 2027/065; H01F 27/2847; H01F 27/24

(57) ABSTRACT

Technologies for an inductor with a meandering conductor are disclosed. In the illustrative embodiment, an inductor has a conductor that follows a meandering U-shaped path. The two nearby conductive strips carrying current in opposite directions largely cancel their magnetic fields, leading to less field on nearby traces on a circuit board. As a result, high-speed traces on the circuit board can be routed near the inductor, resulting in a potentially smaller form factor for the circuit board or a circuit board with few layers.

### BACKGROUND

Circuit boards are ubiquitous in modern electronics. Circuit boards can connect various components, such as voltage regulators and integrated circuit components. Circuit boards can have a large number of connections in multiple layers connecting different components. In some cases, a circuit board can have a high-speed signal trace and a component such as a voltage regulator. In order to prevent or mitigate noise from the voltage regulator, the high-speed signal trace may be routed far away from the voltage regulator, such as 8-13 millimeters away from the voltage regulator.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 illustrates an embodiment of a computing system including an interconnect architecture.

FIG. 2 illustrates an embodiment of an interconnect architecture including a layered stack.

FIG. 3 illustrates an embodiment of a transmitter and receiver pair for an interconnect architecture.

FIG. 4 is a perspective view of one embodiment of a system with a circuit board and inductor, in accordance with one embodiment of the disclosure.

FIG. 5 is a perspective view of the inductor of FIG. 4.

FIG. 6 is a front view of the inductor of FIG. 4.

FIG. 7 is a top-down view of the inductor of FIG. 4.

FIG. 8 is a bottom-up view of the inductor of FIG. 4.

FIG. 9 is a side view of the inductor of FIG. 4.

FIG. 10 is a side view of the system of FIG. 4.

FIG. 11 is a side view of the system of FIG. 4.

FIG. 12 is a plot showing a coupled voltage in a microstrip near one embodiment of the inductor of FIG. 4.

FIG. 13 is a plot showing a magnetic field as a function of distance from one embodiment of the inductor of FIG. 4.

FIG. 14 is a plot showing a current through a voltage regulator as a function of time.

FIG. 15 is a plot showing noise induced on a microstrip by a voltage regulator as a function of time.

FIG. 16 is a side view of one embodiment of the inductor of FIG. 4.

FIG. 17 is a side view of one embodiment of the inductor of FIG. 4.

FIG. 18 is a side view of one embodiment of the inductor of FIG. 4.

FIG. 19 is a side view of one embodiment of the inductor of FIG. 4.

FIG. 20 illustrates an embodiment of a block diagram for a computing system including a multicore processor.

FIG. 21 illustrates an embodiment of a block for a computing system including multiple processors.

### DETAILED DESCRIPTION OF THE DRAWINGS

Small-sized, high-performance computer systems in a variety of form factors are common, such as cell phones, tablets, and laptops. The physical size of these systems requires that high-current power delivery components, such as inductors, be placed near high-speed data buses. However, the magnetic fields associated with the power delivery inductors generate large amounts of noise that can be coupled onto the high-speed buses and cause functional failures. The magnetic noise is not easily mitigated by copper shielding. To reduce the effect of the noise, a large keep-out zone (KOZ) surrounding the inductors may be used, with strict limitations to routing underneath the inductor. The KOZ may be, e.g., 8-13 mm. The KOZ can significantly increase board area and layer count, which can increase the cost, size, and thickness of devices. The large KOZ is applicable to both single-ended (e.g., DDR, GDDR) and differential (e.g., PCIe, USB, display) buses, although single-ended buses are more sensitive. The KOZ may be larger for microstrip layers or sensitive buses and slightly lower for inner routing layers.

Conventional strip inductors are constructed with a metal strip embedded in a ferrite material. A conventional strip inductor may have a pad at each end of a ferrite core with a strip connecting them. The strip inductor can be connected in the path of current flow of a voltage regulator circuit. The magnetic field H from the inductor will intersect with traces routed near the inductor and generate undesired current flow (i.e., noise) in the signal trace.

In order to reduce noise from an inductor, in the illustrative embodiment, an inductor can take a meandering path, such as a U shape. The U-shape passes current in two nearby strips in opposite directions. Because current flow in the parallel strips will be in opposite directions, the generated magnetic field H will be also be in opposite directions. Consequently, the magnetic field H from each half of the U-shaped structure will partially cancel each other, reducing the net magnetic field generated by the inductor and reducing the noise coupled onto nearby signal traces.

In the following description, numerous specific details are set forth, such as examples of specific types of processors and system configurations, specific hardware structures, specific architectural and micro architectural details, specific register configurations, specific instruction types, specific system components, specific measurements/heights, specific processor pipeline stages, and operation, etc. in order to provide a thorough understanding of the present disclosure. It will be apparent, however, to one skilled in the art that these specific details need not be employed to practice embodiments of the present disclosure. In other instances, well-known components or methods, such as specific and alternative processor architectures, specific logic circuits/code for described algorithms, specific firmware code, specific interconnect operation, specific logic configurations, specific manufacturing techniques and materials, specific compiler implementations, specific expression of algorithms in code, specific power down and gating techniques/logic and other specific operational details of a computer system haven't been described in detail in order to avoid unnecessarily obscuring embodiments of the present disclosure.

Although the following embodiments may be described with reference to energy conservation and energy efficiency in specific integrated circuits, such as in computing platforms or microprocessors, other embodiments are applicable to other types of integrated circuits and logic devices. Similar techniques and teachings of embodiments described herein may be applied to other types of circuits or semiconductor devices that may also benefit from better energy efficiency and energy conservation. For example, the disclosed embodiments are not limited to desktop computer systems or Ultrabooks™ and may also be used in other devices, such as handheld devices, tablets, other thin notebooks, systems on a chip (SOC) devices, and embedded applications. Some examples of handheld devices include cellular phones, Internet protocol devices, digital cameras, personal digital assistants (PDAs), and handheld PCs. Embedded applications typically include a microcontroller, a digital signal processor (DSP), a system on a chip, network computers (NetPC), set-top boxes, network hubs, wide area network (WAN) switches, or any other system that can perform the functions and operations taught below. Moreover, the apparatus', methods, and systems described herein are not limited to physical computing devices but may also relate to software optimizations for energy conservation and efficiency. As will become readily apparent in the description below, the embodiments of methods, apparatus', and systems described herein (whether in reference to hardware, firmware, software, or a combination thereof) are vital to a ‘green technology’ future balanced with performance considerations.

As computing systems are advancing, the components therein are becoming more complex. As a result, the interconnect architecture to couple and communicate between the components is also increasing in complexity to ensure bandwidth requirements are met for optimal component operation. Furthermore, different market segments demand different aspects of interconnect architectures to suit the market's needs. For example, servers require higher performance, while the mobile ecosystem is sometimes able to sacrifice overall performance for power savings. Yet, it's a singular purpose of most fabrics to provide highest possible performance with maximum power saving. Below, a number of interconnects are discussed, which would potentially benefit from aspects of the present disclosure.

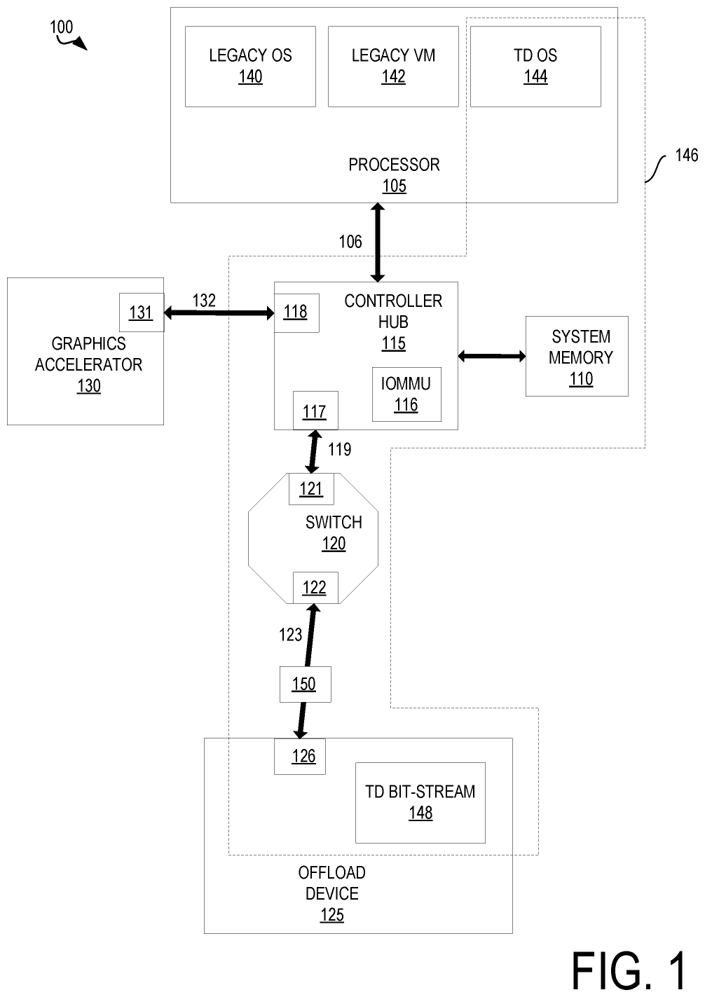

Referring to FIG. 1, an embodiment of a fabric composed of point-to-point links that interconnect a set of components is illustrated. System 100 includes processor 105, controller hub 115, and system memory 110 coupled to controller hub 115. Processor 105 includes any processing element, such as a microprocessor, a host processor, an embedded processor, a co-processor, or other processor. Processor 105 is coupled to controller hub 115 through front-side buses (FSB) 106. It should be appreciated that, in some embodiments, the computing system 100 may include more than one processor. In computing systems 100 with more processors, each pair of processors may be connected by a link. In one embodiment, FSB 106 is a serial point-to-point interconnect as described below. In another embodiment, link 106 includes a serial, differential interconnect architecture that is compliant with different interconnect standard, such as a Quick Path Interconnect (QPI) or an Ultra Path Interconnect (UPI). In some implementations, the system may include logic to implement multiple protocol stacks and further logic to negotiation alternate protocols to be run on top of a common physical layer, among other example features.

System memory 110 includes any memory device, such as random access memory (RAM), non-volatile (NV) memory, or other memory accessible by devices in system 100. In the illustrative embodiment, the system memory 110 is coupled to the controller hub 115. Additionally or alternatively, in some embodiments, the system memory 110 is coupled to processor 105 though a memory interface. Examples of a memory interface include a double-data rate (DDR) memory interface, a dual-channel DDR memory interface, and a dynamic RAM (DRAM) memory interface.

In one embodiment, controller hub 115 is a root hub, root complex, or root controller in a Compute Express Link (CXL) or Peripheral Component Interconnect Express (PCIe or PCIE) interconnection hierarchy. Examples of controller hub 115 include a chipset, a memory controller hub (MCH), a northbridge, an interconnect controller hub (ICH) a southbridge, and a root controller/hub. Often the term chipset refers to two physically separate controller hubs, i.e. a memory controller hub (MCH) coupled to an interconnect controller hub (ICH). Note that current systems often include the MCH integrated with processors 105, while controller 115 is to communicate with I/O devices, in a similar manner as described below. In some embodiments, peer-to-peer routing is optionally supported through root complex 115. In some embodiments, some or all of the controller hub 115 may be integrated with the processor 105.

The controller hub 115 also includes an input/output memory management unit (IOMMU) 116. In some embodiments, the IOMMU 116 may be referred to as a translation agent. In the illustrative embodiment, the IOMMU 116 forms part of the controller hub 115. Additionally or alternatively, in some embodiments, some or all of the IOMMU 116 may be a separate component from the controller hub 115. The IOMMU 116 can include hardware circuitry, software, or a combination of hardware and software. The IOMMU 116 can be used to provide address translation services (ATS) for address spaces in the memory 110 to allow one or more of the offload devices 135 to perform memory transactions to satisfy job requests issued by the host system.

Here, controller hub 115 is coupled to switch/bridge 120 through serial link 119. Input/output modules 117, 121, and 122, which may also be referred to as interfaces/ports 117, 121, and 122 include/implement a layered protocol stack to provide communication between controller hub 115 and switch 120. In one embodiment, multiple devices are capable of being coupled to switch 120. In some embodiments, the port 117 may be referred to as a root port 117.

Switch/bridge 120 routes packets/messages from offload device 125 upstream, i.e., up a hierarchy towards a root complex, to controller hub 115 and downstream, i.e., down a hierarchy away from a root controller, from processor 105 or system memory 110 to offload device 125. Switch 120, in one embodiment, is referred to as a logical assembly of multiple virtual PCI-to-PCI bridge devices. Offload device 125 includes an input/output module 126, which may also be referred to as an interface 126 or port 126. Offload device 125 includes any internal or external device or component to be coupled to an electronic system, such as an I/O device, a Network Interface Controller (NIC), an add-in card, an audio processor, a network processor, a hard-drive, a storage device, a CD/DVD ROM, a monitor, a printer, a mouse, a keyboard, a router, a portable storage device, a Firewire device, a Universal Serial Bus (USB) device, a scanner, an accelerator device, a field programmable gate array (FPGA), an application specific integrated circuit, and other input/output devices. Often in the PCIe vernacular, such as device, is referred to as an endpoint. Although not specifically shown, offload device 125 may include a PCIe to PCI/PCI-X bridge to support legacy or other version PCI devices. Endpoint devices in PCIe are often classified as legacy, PCIe, or root complex integrated endpoints.

Graphics accelerator 130 is also coupled to controller hub 115 through serial link 132. In one embodiment, graphics accelerator 130 is coupled to an MCH, which is coupled to an ICH. Switch 120, and accordingly offload device 125, is then coupled to the ICH. I/O modules 131 and 118 are also to implement a layered protocol stack to communicate between graphics accelerator 130 and controller hub 115. Similar to the MCH discussion above, a graphics controller or the graphics accelerator 130 itself may be integrated in processor 105. Further, one or more links (e.g., 123) of the system can include one or more extension devices (e.g., 150), such as retimers, repeaters, etc.

In the illustrative embodiment, a trusted domain 146 is established the covers a trusted domain operating system (TD OS) 144 on the processor 105 as well as a trusted domain bit-stream 148 on the offload device 125. The illustrative system 100 allows a trusted domain 144 running on the processor 105 to expand the trusted domain 144 into other XPU devices, such as a graphics processing unit (GPU), a field-programmable gate array (FPGA), an accelerator, a smart network interface controller (NIC), etc. In the illustrative embodiment, the XPU device may be embodied as or otherwise included in an offload device 125. The trusted domain can be expanded to include additional hardware, shrunk to include less hardware, merge with another trusted domain, or be split into two or more trusted domains. Trusted domains provides the capability for cloud service providers to offer secure virtual machine isolation to end users or software-as-a-service providers on the cloud. As trusted domains can be expanded and contracted on demand, an expanded domain can be used to handle events such as end of month or quarter spikes.

A trusted and secured protocol provide interfaces and logic to (1) create a compute instantiation (e.g., a bit-stream) to trusted domain of a processor 105, (2) associate XPU resources with the trusted domain, and (3) provide the trusted domain of the processor 105 access to the XPU resources. In order to perform that functionality securely, there must be an attestation flow or root of trust in order to have the processor 105 and XPU trust each other. In some embodiments, the trusted domain OS 144 can exist alongside a legacy OS 140 and/or a legacy virtual machine 142.

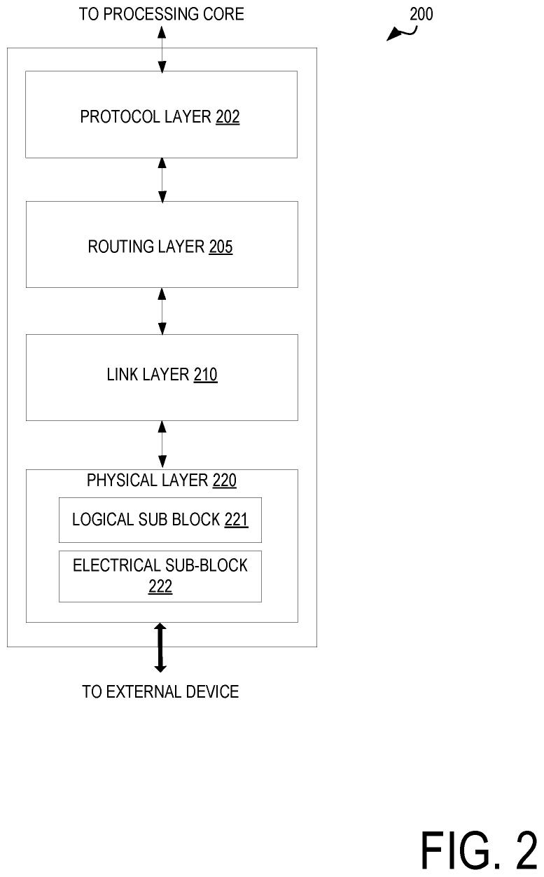

Turning to FIG. 2 an embodiment of a layered protocol stack is illustrated. Layered protocol stack 200 includes any form of a layered communication stack, such as a Quick Path Interconnect (QPI) stack, an Ultra Path Interconnect (UPI) stack, a PCIe stack, a Compute Express Link (CXL), a next generation high performance computing interconnect stack, or other layered stack. Although the discussion immediately below in reference to FIGS. 1-3 are in relation to a UPI stack, the same concepts may be applied to other interconnect stacks. In one embodiment, protocol stack 200 is a UPI protocol stack including protocol layer 202, routing layer 205, link layer 210, and physical layer 220. An interface or link, such as link 109 in FIG. 1, may be represented as communication protocol stack 200. Representation as a communication protocol stack may also be referred to as a module or interface implementing/including a protocol stack.

UPI uses packets to communicate information between components. Packets are formed in the Protocol Layer 202 to carry the information from the transmitting component to the receiving component. As the transmitted packets flow through the other layers, they are extended with additional information necessary to handle packets at those layers. At the receiving side the reverse process occurs and packets get transformed from their Physical Layer 220 representation to the Data Link Layer 210 representation and finally to the form that can be processed by the Protocol Layer 202 of the receiving device.

Protocol Layer

In one embodiment, protocol layer 202 is to provide an interface between a device's processing core and the interconnect architecture, such as data link layer 210 and physical layer 220. In this regard, a primary responsibility of the protocol layer 202 is the assembly and disassembly of packets. The packets may be categorized into different classes, such as home, snoop, data response, non-data response, non-coherent standard, and non-coherent bypass.

Routing Layer

The routing layer 205 may be used to determine the course that a packet will traverse across the available system interconnects. Routing tables may be defined by firmware and describe the possible paths that a packet can follow. In small configurations, such as a two-socket platform, the routing options are limited and the routing tables quite simple. For larger systems, the routing table options may be more complex, giving the flexibility of routing and rerouting traffic.

Link Layer

Link layer 210, also referred to as data link layer 210, acts as an intermediate stage between protocol layer 202 and the physical layer 220. In one embodiment, a responsibility of the data link layer 210 is providing a reliable mechanism for exchanging packets between two components. One side of the data link layer 210 accepts packets assembled by the protocol layer 202, applies an error detection code, i.e., CRC, and submits the modified packets to the physical layer 220 for transmission across a physical to an external device. In receiving packets, the data link layer 210 checks the CRC and, if an error is detected, instructs the transmitting device to resend. In the illustrative embodiment, CRC are performed at the flow control unit (flit) level rather than the packet level. In the illustrative embodiment, each flit is 80 bits. In other embodiments, each flit may be any suitable length, such as 16, 20, 32, 40, 64, 80, or 128 bits.

Physical Layer

In one embodiment, physical layer 220 includes logical sub block 221 and electrical sub-block 222 to physically transmit a packet to an external device. Here, logical sub-block 221 is responsible for the “digital” functions of Physical Layer 220. In this regard, the logical sub-block includes a transmit section to prepare outgoing information for transmission by physical sub-block 222, and a receiver section to identify and prepare received information before passing it to the Link Layer 210.

Physical block 222 includes a transmitter and a receiver. The transmitter is supplied by logical sub-block 221 with symbols, which the transmitter serializes and transmits onto to an external device. The receiver is supplied with serialized symbols from an external device and transforms the received signals into a bit-stream. The bit-stream is de-serialized and supplied to logical sub-block 221. In the illustrative embodiment, the physical layer 220 sends and receives bits in groups of 20 bits, called a physical unit or phit. In some embodiments, a line coding, such as an 8b/10b transmission code or a 64b/66b transmission code, is employed. In some embodiments, special symbols are used to frame a packet with frames 223. In addition, in one example, the receiver also provides a symbol clock recovered from the incoming serial stream.

As stated above, although protocol layer 202, routing layer 205, link layer 210, and physical layer 220 are discussed in reference to a specific embodiment of a QPI protocol stack, a layered protocol stack is not so limited. In fact, any layered protocol may be included/implemented. As an example, a port/interface that is represented as a layered protocol includes: (1) a first layer to assemble packets, i.e. a protocol layer; a second layer to sequence packets, i.e. a link layer; and a third layer to transmit the packets, i.e. a physical layer. As a specific example, a common standard interface (CSI) layered protocol is utilized.

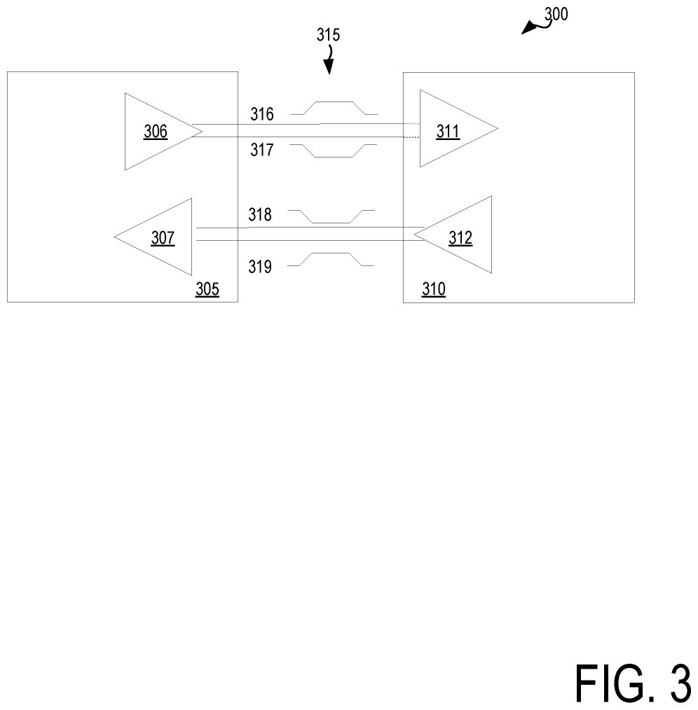

Referring next to FIG. 3, an embodiment of a UPI serial point-to-point link is illustrated. Although an embodiment of a UPI serial point-to-point link is illustrated, a serial point-to-point link is not so limited, as it includes any transmission path for transmitting serial data. In the embodiment shown, a basic UPI serial point-to-point link includes two, low-voltage, differentially driven signal pairs: a transmit pair 306/312 and a receive pair 311/307. Accordingly, device 305 includes transmission logic 306 to transmit data to device 310 and receiving logic 307 to receive data from device 310. In other words, two transmitting paths, i.e. paths 316 and 317, and two receiving paths, i.e. paths 318 and 319, are included in a UPI link.

A transmission path refers to any path for transmitting data, such as a transmission line, a copper line, an optical line, a wireless communication channel, an infrared communication link, or other communication path. A connection between two devices, such as device 305 and device 310, is referred to as a link, such as link 315. A link may support one lane—each lane representing a set of differential signal pairs (one pair for transmission, one pair for reception). To scale bandwidth, a link may aggregate multiple lanes denoted by xN, where N is any supported Link width, such as 1, 2, 4, 5, 8, 10, 12, 16, 20, 32, 64, or wider. In some implementations, each symmetric lane contains one transmit differential pair and one receive differential pair. Asymmetric lanes can contain unequal ratios of transmit and receive pairs. Some technologies can utilize symmetric lanes (e.g., UPI), while others (e.g., Displayport) may not and may even including only transmit or only receive pairs, among other examples. A link may refer to a one-way link (such as the link established by transmission logic 306 and receive logic 311) or may refer to a bi-directional link (such as the links established by transmission logic 306 and 312 and receive logic 307 and 311).

A differential pair refers to two transmission paths, such as lines 316 and 317, to transmit differential signals. As an example, when line 316 toggles from a low voltage level to a high voltage level, i.e. a rising edge, line 317 drives from a high logic level to a low logic level, i.e. a falling edge. Differential signals potentially demonstrate better electrical characteristics, such as better signal integrity, i.e. cross-coupling, voltage overshoot/undershoot, ringing, etc. This allows for better timing window, which enables faster transmission frequencies.

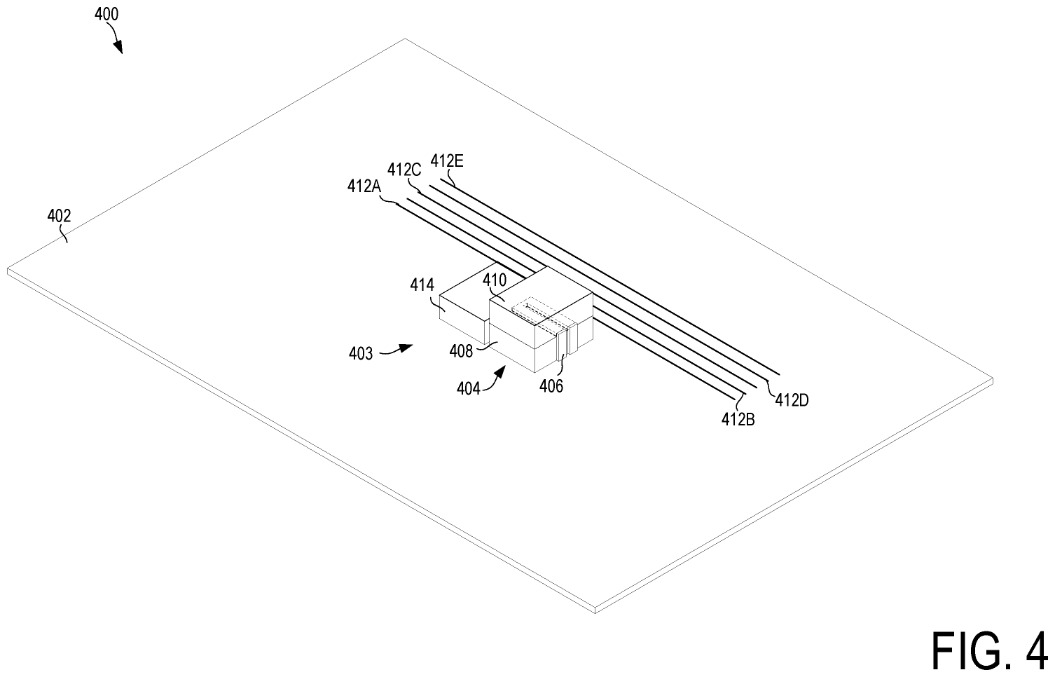

Referring now to FIG. 4, in one embodiment, a system 400 includes a circuit board 402 and a voltage regulator 403 mounted on the top surface of the circuit board 402. The circuit board 402 includes several microstrips 412A-E on the surface of the circuit 402. The voltage regulator 403 includes an inductor 404 and one or more additional voltage regulator components 414. The inductor 404 includes a conductor 406 embedded in a magnetic core. In the illustrative embodiment, the magnetic core has a lower portion 408 and an upper portion 410 that substantially surround part of the conductor 406. As discussed in more detail below, a current path through the conductor 406 of the inductor 404 passes through the magnetic core first in one direction and then in another, making a U-shape.

It should be appreciated that, as used herein, the “top side,” “top surface,” “bottom side,” etc., of the circuit board 402 as well as relative positioning terms such as “above” and “below” are arbitrary designations used for clarity and do not denote a particular required orientation for manufacture or use. Although the illustrative embodiment described has the voltage regulator 403 placed on the “top” side of the circuit board 402, in some embodiments, the voltage regulator 403 may additionally or alternatively be placed on the “bottom” side of the circuit board 402.

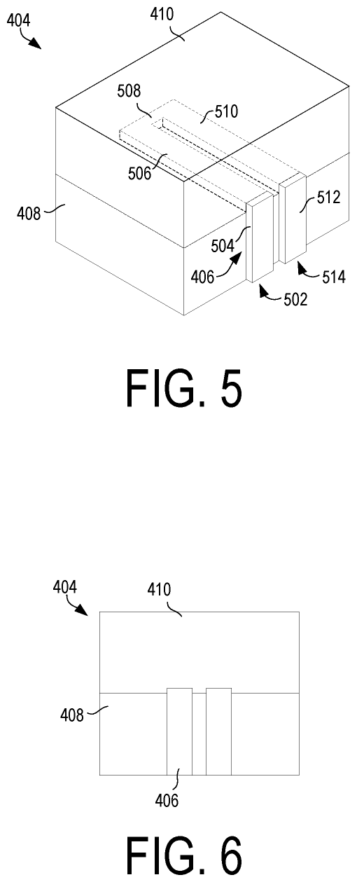

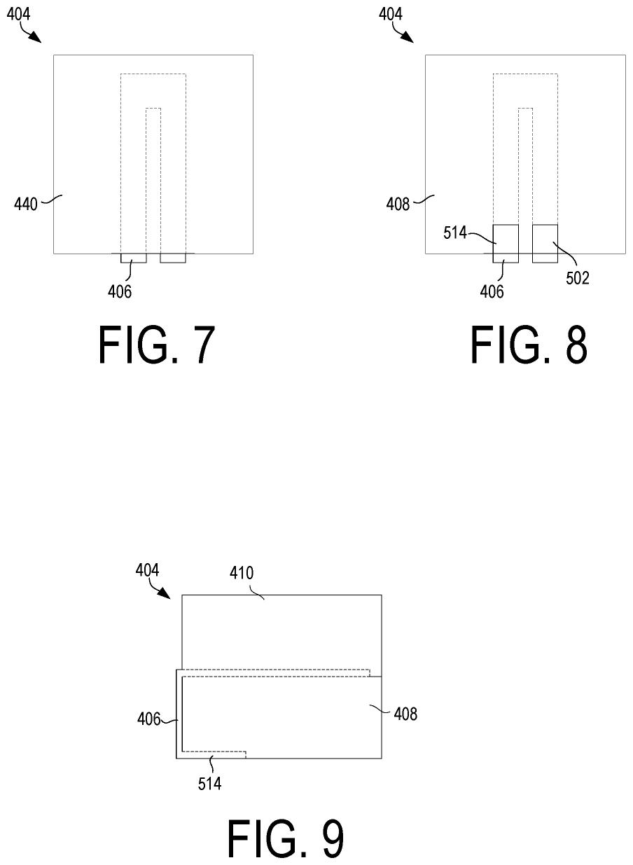

FIGS. 5-9 show various views of the inductor 404. FIG. 5 shows an isometric view of the inductor 404. FIG. 6 shows a front view of the inductor 404. FIG. 7 shows a top-down view of the inductor 404. FIG. 8 shows a bottom-up view of the inductor 404. FIG. 9 shows a side view of the inductor 404.

The conductor 406 of the inductor 404 has a contact pad 502 (see FIG. 8) that contacts the surface of the circuit board 402 or other component. A conductive riser strip 504 connects the contact pad 502 to a conductive strip 506 that is surrounded by the magnetic core 408, 410. Another contact pad 514, conductive riser strip 512, and conductive strip 510 that is surrounded by the magnetic core 408, 410 are positioned near the contact pad 502, conductive riser strip 504, and conductive strip 506. A bridging conductive strip 508 connects the ends of the conductive strips 506, 510 at a distal end of the conductive strips 506, 510 relative to the conductive riser strips 504, 512. A current path through the inductor 404 goes from the contact pad 502, to the conductive riser strip 504, to conductive strip 506, to bridging strip 508, to conductive strip 510, to conductive riser strip 512, to contact pad 514.

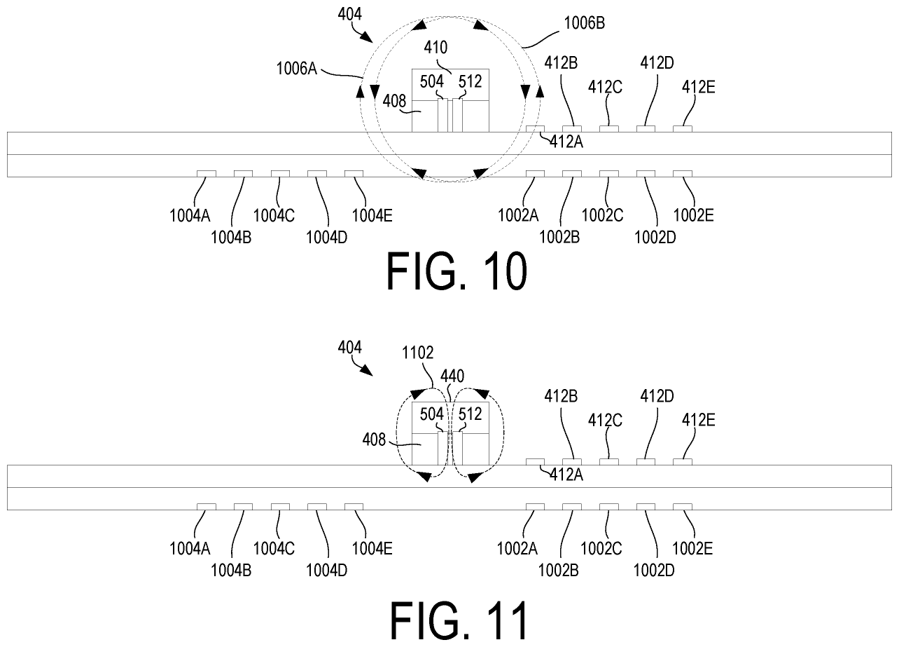

FIGS. 10 and 11 show a side view of the system 100. As shown in FIGS. 10 and 11, the circuit board 402 includes multiple layers. The system 100 has several microstrips 412A-E on the top layer, and several strip lines 1002A-E, 1004A-E.

In use, in one embodiment, current flows into the inductor through riser conductive strip 504 then passes through the conductive strip 506 (into the page in FIGS. 10 and 11). The current returns through the conductive strip 510 (out of the page in FIGS. 10 and 11) and exits the inductor through riser conductive strip 504.

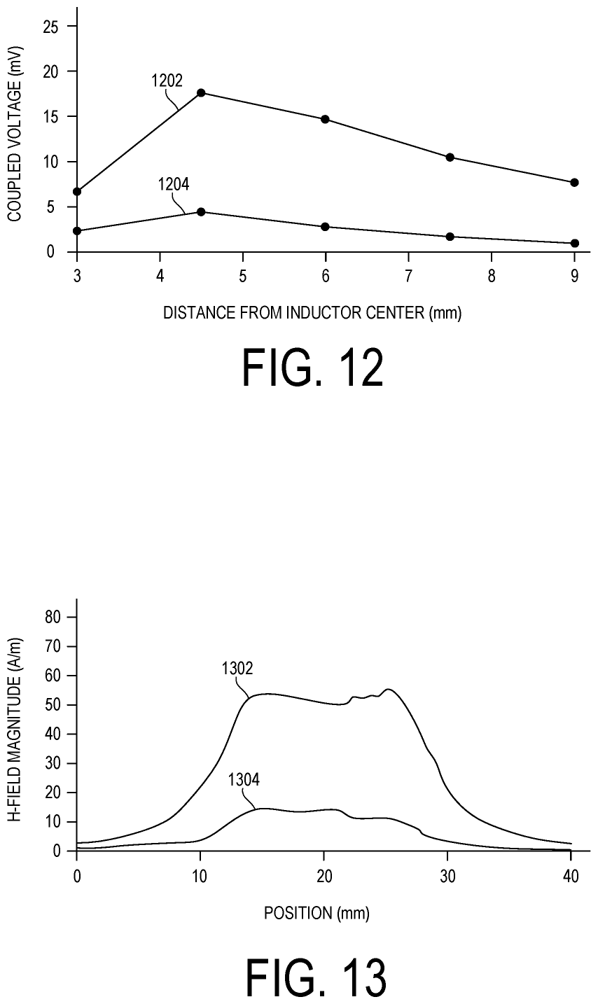

As shown in FIG. 10, current that passes through the conductive strip 506 (into the page) creates a magnetic field H 1006A in a clockwise direction. Of course, in some embodiments, current may additionally or alternatively flow in an opposite direction, in which case the direction of the magnetic field will be reversed. The magnetic field H 1006A is approximately the field that would be induced by a conventional strip inductor with the same current passing through it. The current that passes through the conductive strip 510 (out of the page) creates a magnetic field H 1006B in a clockwise direction. The magnetic field H 1006B is roughly equal and opposite to the magnetic field H 1006A but slightly offset from the magnetic field H 1006A. As a result, the combined fields H 1006A, 1006B results in the field 1102 shown in FIG. 11. The field H 1102 induces less noise on the microstrips 412A-E and the strip lines 1002A-E, 1004A-E, as discussed in more detail below in regard to FIGS. 12-15.

In the illustrative embodiment, the circuit board 402 is a fiberglass board made of glass fibers and a resin, such as FR-4. In other embodiments, any suitable circuit board 402 may be used. In some embodiments, the inductor 404 may be mounted directly on another component or chip instead of being mounted on the circuit board 402. The thickness of each layer of the circuit board 402 can be any suitable thickness, such as 50 to 500 micrometers. The circuit board 402 may have any suitable number of layers, such as 1-10. The total thickness of the circuit board 402 may be any suitable thickness, such as 100 micrometers to 5 millimeters. The circuit board 402 can have any suitable length and width, such as 5-500 millimeters. Although shown as a rectangle, it should be appreciated that the circuit board 402 may be any suitable shape and may have protrusions, cutouts, etc., in order to accommodate, fit, or touch other components of a device. In the illustrative embodiment, the circuit board 402 is planar. In other embodiments, some or all of the circuit board 402 may be non-planar.

In the illustrative embodiment, the conductor 406 of the inductor 404 is able to carry large amounts of current, such as 1-100 amps.

Each microstrip 412A-E, strip line 1002A-E, 1004A-E and/or other trace on the circuit board 402 may have any suitable width, such as any width from 0.05-20 millimeters. In the illustrative embodiment, signal traces such as microstrips 412A-E may have a width of 0.1-0.15 millimeters. Each trace on the circuit board may have any suitable height, such as any height from 5 micrometers to 40 micrometers. In the illustrative embodiment, the height of each trace, such as microstrips 412A-E, is 20-25 micrometers.

In the illustrative embodiment, each of the microstrips 412A-E, strip lines 1002A-E, 1004A-E and/or other traces on the board 402 are made of copper. In other embodiments, some or all of the microstrips 412A-E, strip lines 1002A-E, 1004A-E and/or other traces on the board 402 may be made of or include other materials, such as silver, aluminum, gold, etc. In some embodiments, some or all of the microstrips 412A-E, strip lines 1002A-E, 1004A-E and/or other traces on the board 402 may be made of a non-metallic conductor.

In the illustrative embodiment, there are several microstrips 412A-E and strip lines 1002A-E, 1004A-E corresponding to a single-ended or differential signal that can carry high-speed signals. As used herein, a high-speed signal trace refers to a trace that connects two or more circuit components that will, in use, transmit and/or receive a signal on the high-speed signal trace at an analog frequency of 100 megahertz or higher, unless a different speed is explicitly specified. High-speed signal traces may be used for any suitable signal, such as a peripheral component interconnect express (PCIe) interconnect (e.g., a PCIe 6 interconnect), a memory interconnect (such as a DDR or GDDR memory interconnect), a compute express link (CXL) interconnect, a USB interconnect, a display interconnect, etc. In some embodiments, at least part of the high-speed signal traces are directly below the voltage regulator 403 and not displaced to one side or the other. In other embodiments, some or all of a high-speed signal trace may be laterally displaced from directly below the voltage regulator 403, such as laterally displaced by 0-8 millimeters. In some embodiments, the lateral displacement for high-speed signal traces relative to the voltage regulator 403 may be referred to as a keep-out zone (KOZ) of the voltage regulator 403. It should be appreciated that the reduced external field of the inductor 404 may allow the signal traces to be closer to the voltage regulator 403 than they might otherwise be able to be (i.e., the keep-out zone may be smaller). As a result, the circuit board 402 may have a smaller form factor than it otherwise would without inductor 404. Additionally or alternatively, the circuit board 402 may have fewer layers than it otherwise would without the inductor 404, as more of the circuit board 402 may be available to use to route high-speed signal traces.

The inductor 404 may have any suitable size. The inductor 404 may have a length of, e.g., 3-60 millimeters and a width of, e.g., 2-40 millimeters. In the illustrative embodiment, the inductor 404 has a length of about 12.6 millimeters and a width of about 7.8 millimeters The inductor 404 may have any suitable thickness, such as 1-30 millimeters. In the illustrative embodiment, the inductor 404 has a height of about 4.3 millimeters.

In the illustrative embodiment, the conductor 406 of the inductor 404 is made out of copper. In other embodiments, it may be made out of a different material, such as aluminum or other suitable conductive material. The conductive strips 506, 510 may have any suitable length, such as 2-50 millimeters. In the illustrative embodiment, the conductive strips 506, 510 have a length of about 12.5 millimeters. The width of each conductive strip 506, 510 may be, e.g., 0.3-6 millimeters. In the illustrative embodiment, the conductive strips 506, 510 have a width of about 1.5 millimeters. The thickness of each conductive strip 506, 510 may be, e.g., 0.1-3 millimeters. In the illustrative embodiment, the thickness of each conductive strip 506, 510 is about 0.4 millimeters. The gap between conductive strips 506, 510 may have any suitable width, such as 0.1-3 millimeters. In the illustrative embodiment, the gap between conductive strips 506, 510 is about 0.5 millimeters.

The inductance of the inductor 404 may be any suitable value, such as 10-500 nH. In the illustrative embodiment, the inductor 404 has an inductance of 110 nH. In the illustrative embodiment, the inductor 404 has a similar inductance to a conventional strip inductor with the same form factor. In other embodiments, the inductor 404 may have a larger or smaller inductance than a similarly sized conventional strip inductor. For example, the gap between the conductive strips 506, 510 may be increased to increase the inductance of the inductor 404 or may be decreased to decrease the inductance of the inductor 404. In the illustrative embodiment, the width of each conductive strip 506, 510 is less than the width of a single conductive strip found in a similar location in a conventional strip inductor. If the thickness and length remains the same, then the resistance of the inductor 404 with a meandering conductor 406 will be higher than the resistance of a similar conventional strip inductor. However, the conductive strips 506, 510 may have an increased width or thickness to reduce the resistance.

The magnetic core components 408, 410 may be any suitable magnetic material. In the illustrative embodiment, the magnetic core components 408, 410 are made of a ferrite material. In other embodiments, a different material may be used.

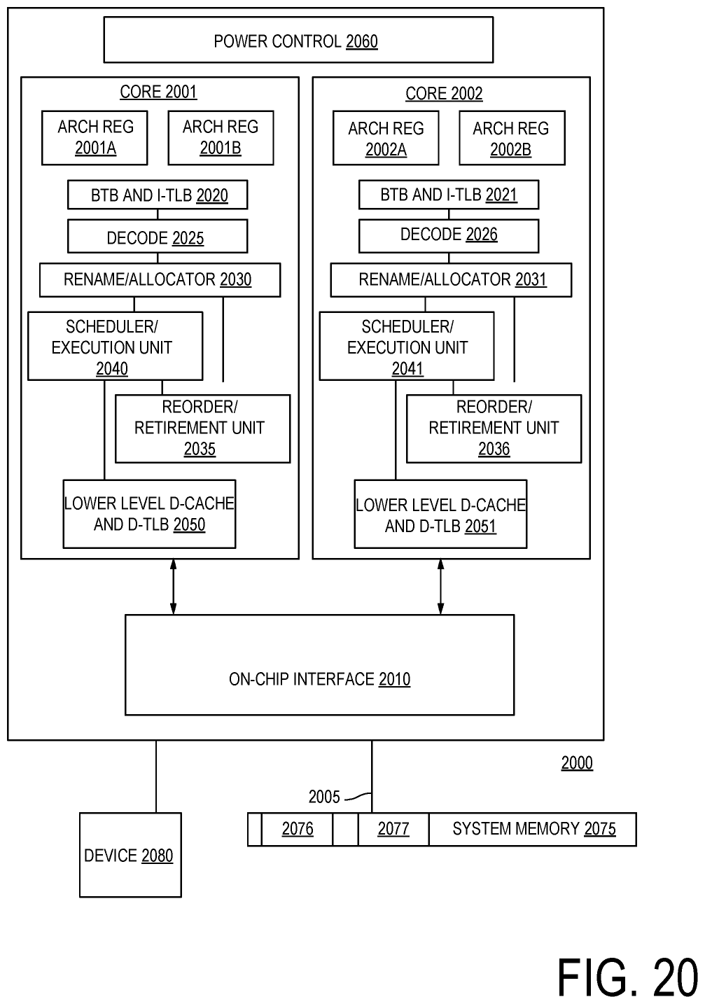

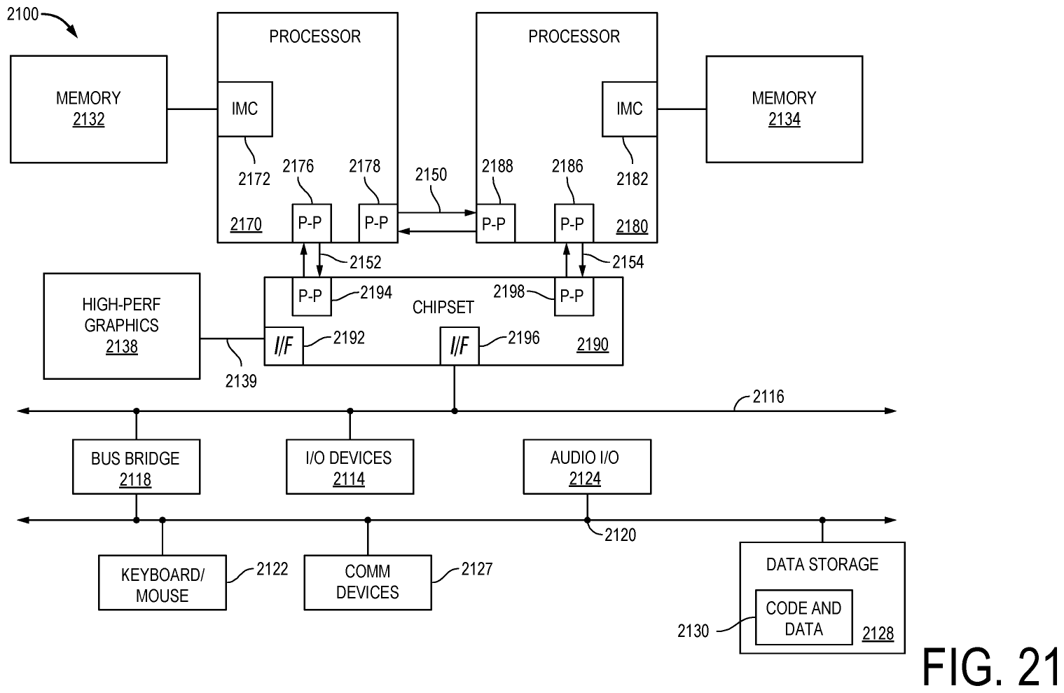

The circuit board 402 may include several other traces or connections not shown in the figures, such as connections between various integrated circuit components such as a processor circuit, a memory circuit, a display circuit, power components, circuit components, etc. In some embodiments, the circuit board 402 may include one or more vias, connecting one trace layer to another. In some embodiments, the circuit board 402 may interface with or be embodied as, e.g., the processor 2000, system memory 2075, etc., processor 2170, memory 2132, etc., described below in regard to FIGS. 20 and 21.

The inductor 404 allows design of a quiet power inductor that reduces or minimizes magnetic noise coupled onto high-speed signals by more the three times compared to a conventional strip inductor without sacrificing board area, inductor size, inductor efficiency, or layer count. The inductor 404 can enable a smaller motherboard with a lower layer count that is not practical with conventional strip inductors. The inductor 404 will allow the development of small form factors and reduce the risk of routing near inductors for different types of systems.

Referring now to FIG. 12, in one embodiment, a plot shows a simulated coupled voltage on, e.g., the microstrips 412A-412E as a function of the distance of the microstrips 412A-412E from a center of the inductor. Line 1202 shows the coupled noise as a function of the distance from a conventional strip inductor, and line 1204 shows the coupled noise as a function of the distance from the inductor 404. Simulations show a three to four times reduction of coupled noise onto transmission lines when routed near the U-shaped inductor 404 compared to a similar conventional strip inductor. As a result, traces can be routed three to four times closer to the inductor 404 as compared to requirements for a conventional strip inductor. For example, the KOZ may drop from, e.g., 8-13 millimeters for a conventional strip inductor to less than 3 millimeters for the inductor 404, as measured from the edge of the inductor 404.

Referring now to FIG. 13, in one embodiment, a plot shows a simulated magnetic field as a function of position along a trace near an inductor. The simulation is for a trace (such as microstrip 412A) that is laterally displaced six millimeters from the center of the inductor 404. The center of the inductor is positioned at 20 millimeters on the plot shown in FIG. 13. Line 1302 shows the magnetic field along the trace as a function of position for a conventional strip inductor, and line 1304 shows the magnetic field along the trace as a function of position for the inductor 404. As can be seen in the plot, the H-field for inductor 404 is less than 15 A/m, while, for the conventional strip inductor, the H-field is higher than 30 A/m, leading to a corresponding reduction in the noise for the U-shaped inductor 404.

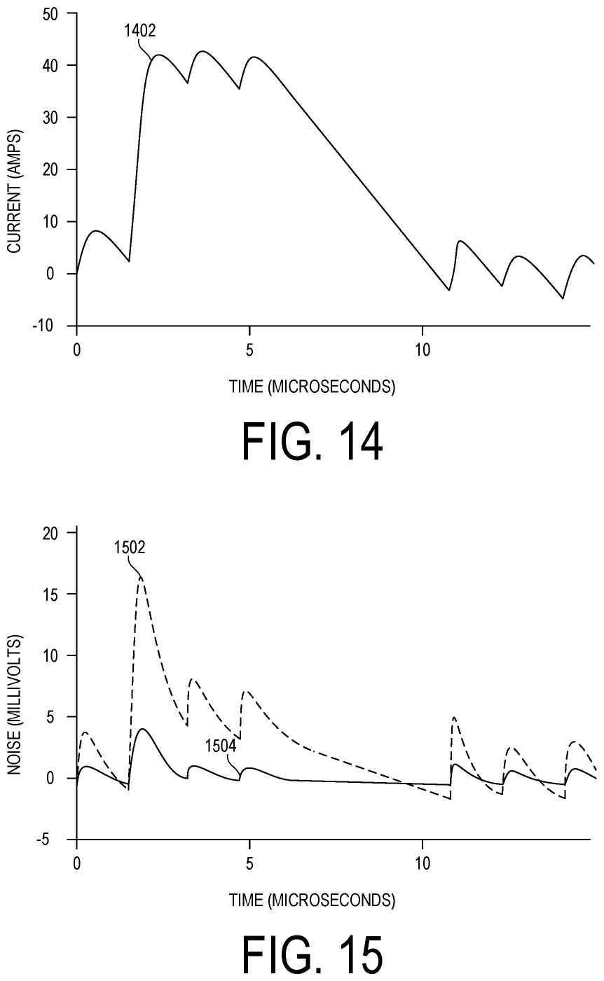

Referring now to FIGS. 14 and 15, in one embodiment, a time-varying current is passed through an inductor, and a noise voltage coupled to a nearby microstrip is plotted. The microstrip is 4.5 millimeters away from the center of the inductor. The inductors are driven with a current source representative of a typical high-current rail. FIG. 14 shows a plot with the simulated current 1402 as a function of time. FIG. 15 shows a plot with the simulated noise voltage for a conventional strip inductor represented by the line 1502 and the noise voltage for the inductor 404 represented by the line 1504. FIG. 15 shows that the coupled voltage onto the transmission line is only about 4 mV from the U-shaped inductor 404 compared to about 17 mV from the conventional strip inductor, which is about a four times reduction in noise.

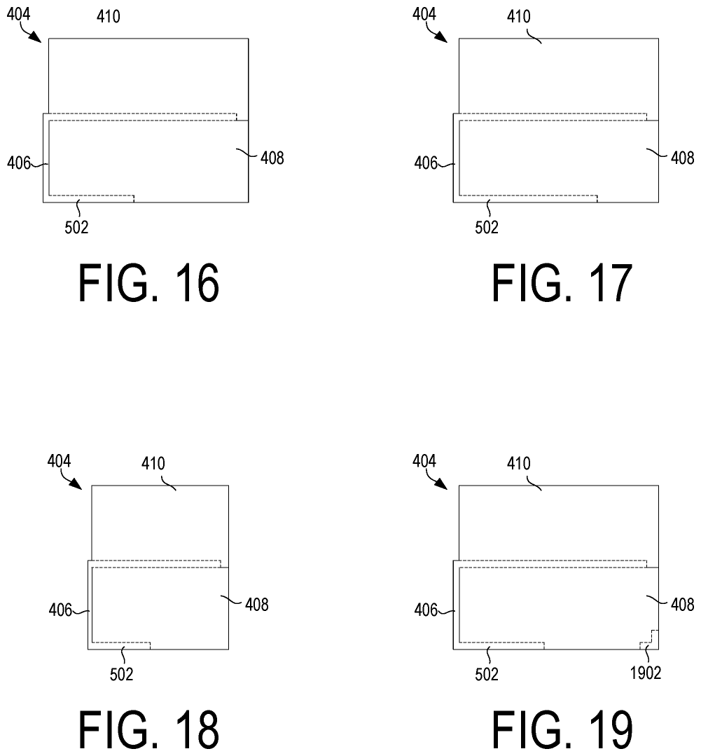

Referring now to FIGS. 16-19, side views of various embodiments of the inductor 404 are shown. FIGS. 16 and 17 show an inductor 404 with the contact pads 502, 514 extended to longer lengths, which may provide better layout connectivity. FIG. 18 shows the inductor 404 that is not as long, which may use a larger meander loop structure. For example, the conductor 406 may meander two or more times, forming, e.g., a W shape instead of a U shape. FIG. 19 shows an inductor 404 with an additional contact pad 1902 not connected to the conductor 406. The contact pad 1902 may provide additional stability.

It should be appreciated that the embodiments described above are not the only possible embodiments of an inductor 404 with a meandering conductor 406. For example, the meandering part of the conductor 406 may be in a plane that is perpendicular to the circuit board 402 instead of parallel to it. The conductor 406 may meander more than once or otherwise take a different path than the one shown in, e.g., FIG. 5.

Referring to FIG. 20, an embodiment of a block diagram for a computing system including a multicore processor is depicted. Processor 2000 includes any processor or processing device, such as a microprocessor, an embedded processor, a digital signal processor (DSP), a network processor, a handheld processor, an application processor, a co-processor, a system on a chip (SOC), or other device to execute code. Processor 2000, in one embodiment, includes at least two cores—core 2001 and 2002, which may include asymmetric cores or symmetric cores (the illustrated embodiment). However, processor 2000 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core often refers to logic located on an integrated circuit capable of maintaining an independent architectural state, wherein each independently maintained architectural state is associated with at least some dedicated execution resources. In contrast to cores, a hardware thread typically refers to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical processor 2000, as illustrated in FIG. 20, includes two cores—core 2001 and 2002. Here, core 2001 and 2002 are considered symmetric cores, i.e. cores with the same configurations, functional units, and/or logic. In another embodiment, core 2001 includes an out-of-order processor core, while core 2002 includes an in-order processor core. However, cores 2001 and 2002 may be individually selected from any type of core, such as a native core, a software managed core, a core adapted to execute a native Instruction Set Architecture (ISA), a core adapted to execute a translated Instruction Set Architecture (ISA), a co-designed core, or other known core. In a heterogeneous core environment (i.e. asymmetric cores), some form of translation, such a binary translation, may be utilized to schedule or execute code on one or both cores. Yet to further the discussion, the functional units illustrated in core 2001 are described in further detail below, as the units in core 2002 operate in a similar manner in the depicted embodiment.

As depicted, core 2001 includes two hardware threads 2001a and 2001b, which may also be referred to as hardware thread slots 2001a and 2001b. Therefore, software entities, such as an operating system, in one embodiment potentially view processor 2000 as four separate processors, i.e., four logical processors or processing elements capable of executing four software threads concurrently. As alluded to above, a first thread is associated with architecture state registers 2001a, a second thread is associated with architecture state registers 2001b, a third thread may be associated with architecture state registers 2002a, and a fourth thread may be associated with architecture state registers 2002b. Here, each of the architecture state registers (2001a, 2001b, 2002a, and 2002b) may be referred to as processing elements, thread slots, or thread units, as described above. As illustrated, architecture state registers 2001a are replicated in architecture state registers 2001b, so individual architecture states/contexts are capable of being stored for logical processor 2001a and logical processor 2001b. In core 2001, other smaller resources, such as instruction pointers and renaming logic in allocator and renamer block 2030 may also be replicated for threads 2001a and 2001b. Some resources, such as re-order buffers in reorder/retirement unit 2035, ILTB 2020, load/store buffers, and queues may be shared through partitioning. Other resources, such as general purpose internal registers, page-table base register(s), low-level data-cache and data-TLB 2015, execution unit(s) 2040, and portions of out-of-order unit 2035 are potentially fully shared.

Processor 2000 often includes other resources, which may be fully shared, shared through partitioning, or dedicated by/to processing elements. In FIG. 20, an embodiment of a purely exemplary processor with illustrative logical units/resources of a processor is illustrated. Note that a processor may include, or omit, any of these functional units, as well as include any other known functional units, logic, or firmware not depicted. As illustrated, core 2001 includes a simplified, representative out-of-order (000) processor core. But an in-order processor may be utilized in different embodiments. The 000 core includes a branch target buffer 2020 to predict branches to be executed/taken and an instruction-translation buffer (I-TLB) 2020 to store address translation entries for instructions.

Core 2001 further includes decode module 2025 coupled to fetch unit 2020 to decode fetched elements. Fetch logic, in one embodiment, includes individual sequencers associated with thread slots 2001a, 2001b, respectively. Usually core 2001 is associated with a first ISA, which defines/specifies instructions executable on processor 2000. Often machine code instructions that are part of the first ISA include a portion of the instruction (referred to as an opcode), which references/specifies an instruction or operation to be performed. Decode logic 2025 includes circuitry that recognizes these instructions from their opcodes and passes the decoded instructions on in the pipeline for processing as defined by the first ISA. For example, as discussed in more detail below decoders 2025, in one embodiment, include logic designed or adapted to recognize specific instructions, such as transactional instruction. As a result of the recognition by decoders 2025, the architecture or core 2001 takes specific, predefined actions to perform tasks associated with the appropriate instruction. It is important to note that any of the tasks, blocks, operations, and methods described herein may be performed in response to a single or multiple instructions; some of which may be new or old instructions. Note decoders 2026, in one embodiment, recognize the same ISA (or a subset thereof). Alternatively, in a heterogeneous core environment, decoders 2026 recognize a second ISA (either a subset of the first ISA or a distinct ISA).

In one example, allocator and renamer block 2030 includes an allocator to reserve resources, such as register files to store instruction processing results. However, threads 2001a and 2001b are potentially capable of out-of-order execution, where allocator and renamer block 2030 also reserves other resources, such as reorder buffers to track instruction results. Unit 2030 may also include a register renamer to rename program/instruction reference registers to other registers internal to processor 2000. Reorder/retirement unit 2035 includes components, such as the reorder buffers mentioned above, load buffers, and store buffers, to support out-of-order execution and later in-order retirement of instructions executed out-of-order.

Scheduler and execution unit(s) block 2040, in one embodiment, includes a scheduler unit to schedule instructions/operation on execution units. For example, a floating point instruction is scheduled on a port of an execution unit that has an available floating point execution unit. Register files associated with the execution units are also included to store information instruction processing results. Exemplary execution units include a floating point execution unit, an integer execution unit, a jump execution unit, a load execution unit, a store execution unit, and other known execution units.

Lower level data cache and data translation buffer (D-TLB) 2050 are coupled to execution unit(s) 2040. The data cache is to store recently used/operated on elements, such as data operands, which are potentially held in memory coherency states. The D-TLB is to store recent virtual/linear to physical address translations. As a specific example, a processor may include a page table structure to break physical memory into a plurality of virtual pages.

Here, cores 2001 and 2002 share access to higher-level or further-out cache, such as a second level cache associated with on-chip interface 2010. Note that higher-level or further-out refers to cache levels increasing or getting further way from the execution unit(s). In one embodiment, higher-level cache is a last-level data cache—last cache in the memory hierarchy on processor 2000—such as a second or third level data cache. However, higher level cache is not so limited, as it may be associated with or include an instruction cache. A trace cache—a type of instruction cache—instead may be coupled after decoder 2025 to store recently decoded traces. Here, an instruction potentially refers to a macro-instruction (i.e. a general instruction recognized by the decoders), which may decode into a number of micro-instructions (micro-operations).

In the depicted configuration, processor 2000 also includes on-chip interface module 2010. Historically, a memory controller, which is described in more detail below, has been included in a computing system external to processor 2000. In this scenario, on-chip interface 2010 is to communicate with devices external to processor 2000, such as system memory 2075, a chipset (often including a memory controller hub to connect to memory 2075 and an I/O controller hub to connect peripheral devices), a memory controller hub, a northbridge, or other integrated circuit. And in this scenario, bus 2005 may include any known interconnect, such as multi-drop bus, a point-to-point interconnect, a serial interconnect, a parallel bus, a coherent (e.g. cache coherent) bus, a layered protocol architecture, a differential bus, and a GTL bus.

Memory 2075 may be dedicated to processor 2000 or shared with other devices in a system. Common examples of types of memory 2075 include DRAM, SRAM, non-volatile memory (NV memory), and other known storage devices. Note that device 2080 may include a graphic accelerator, processor or card coupled to a memory controller hub, data storage coupled to an I/O controller hub, a wireless transceiver, a flash device, an audio controller, a network controller, or other known device.

Recently however, as more logic and devices are being integrated on a single die, such as SOC, each of these devices may be incorporated on processor 2000. For example in one embodiment, a memory controller hub is on the same package and/or die with processor 2000. Here, a portion of the core (an on-core portion) 2010 includes one or more controller(s) for interfacing with other devices such as memory 2075 or a graphics device 2080. The configuration including an interconnect and controllers for interfacing with such devices is often referred to as an on-core (or un-core configuration). As an example, on-chip interface 2010 includes a ring interconnect for on-chip communication and a high-speed serial point-to-point link 2005 for off-chip communication. Yet, in the SOC environment, even more devices, such as the network interface, co-processors, memory 2075, graphics processor 2080, and any other known computer devices/interface may be integrated on a single die or integrated circuit to provide small form factor with high functionality and low power consumption.

In one embodiment, processor 2000 is capable of executing a compiler, optimization, and/or translator code 2077 to compile, translate, and/or optimize application code 2076 to support the apparatus and methods described herein or to interface therewith. A compiler often includes a program or set of programs to translate source text/code into target text/code. Usually, compilation of program/application code with a compiler is done in multiple phases and passes to transform hi-level programming language code into low-level machine or assembly language code. Yet, single pass compilers may still be utilized for simple compilation. A compiler may utilize any known compilation techniques and perform any known compiler operations, such as lexical analysis, preprocessing, parsing, semantic analysis, code generation, code transformation, and code optimization.

Larger compilers often include multiple phases, but most often these phases are included within two general phases: (1) a front-end, i.e. generally where syntactic processing, semantic processing, and some transformation/optimization may take place, and (2) a back-end, i.e. generally where analysis, transformations, optimizations, and code generation takes place. Some compilers refer to a middle, which illustrates the blurring of delineation between a front-end and back end of a compiler. As a result, reference to insertion, association, generation, or other operation of a compiler may take place in any of the aforementioned phases or passes, as well as any other known phases or passes of a compiler. As an illustrative example, a compiler potentially inserts operations, calls, functions, etc. in one or more phases of compilation, such as insertion of calls/operations in a front-end phase of compilation and then transformation of the calls/operations into lower-level code during a transformation phase. Note that during dynamic compilation, compiler code or dynamic optimization code may insert such operations/calls, as well as optimize the code for execution during runtime. As a specific illustrative example, binary code (already compiled code) may be dynamically optimized during runtime. Here, the program code may include the dynamic optimization code, the binary code, or a combination thereof.

Similar to a compiler, a translator, such as a binary translator, translates code either statically or dynamically to optimize and/or translate code. Therefore, reference to execution of code, application code, program code, or other software environment may refer to: (1) execution of a compiler program(s), optimization code optimizer, or translator either dynamically or statically, to compile program code, to maintain software structures, to perform other operations, to optimize code, or to translate code; (2) execution of main program code including operations/calls, such as application code that has been optimized/compiled; (3) execution of other program code, such as libraries, associated with the main program code to maintain software structures, to perform other software related operations, or to optimize code; or (4) a combination thereof.

Referring now to FIG. 21, shown is a block diagram of another system 2100 in accordance with an embodiment of the present disclosure. As shown in FIG. 21, multiprocessor system 2100 is a point-to-point interconnect system, and includes a first processor 2170 and a second processor 2180 coupled via a point-to-point interconnect 2150. Each of processors 2170 and 2180 may be some version of a processor. In one embodiment, 2152 and 2154 are part of a serial, point-to-point coherent interconnect fabric, such as a high-performance architecture. As a result, aspects of the present disclosure may be implemented within the QPI architecture.

While shown with only two processors 2170, 2180, it is to be understood that the scope of the present disclosure is not so limited. In other embodiments, one or more additional processors may be present in a given processor.

Processors 2170 and 2180 are shown including integrated memory controller units 2172 and 2182, respectively. Processor 2170 also includes as part of its bus controller units point-to-point (P-P) interfaces 2176 and 2178; similarly, second processor 2180 includes P-P interfaces 2186 and 2188. Processors 2170, 2180 may exchange information via a point-to-point (P-P) interface 2150 using P-P interface circuits 2178, 2188. As shown in FIG. 21, IMCs 2172 and 2182 couple the processors to respective memories, namely a memory 2132 and a memory 2134, which may be portions of main memory locally attached to the respective processors.

Processors 2170, 2180 each exchange information with a chipset 2190 via individual P-P interfaces 2152, 2154 using point to point interface circuits 2176, 2194, 2186, 2198. Chipset 2190 also exchanges information with a high-performance graphics circuit 2138 via an interface circuit 2192 along a high-performance graphics interconnect 2139.

A shared cache (not shown) may be included in either processor or outside of both processors; yet connected with the processors via P-P interconnect, such that either or both processors' local cache information may be stored in the shared cache if a processor is placed into a low power mode.

Chipset 2190 may be coupled to a first bus 2116 via an interface 2196. In one embodiment, first bus 2116 may be a Peripheral Component Interconnect (PCI) bus, or a bus such as a PCI Express bus or another third generation I/O interconnect bus, although the scope of the present disclosure is not so limited.

As shown in FIG. 21, various I/O devices 2114 are coupled to first bus 2116, along with a bus bridge 2118 which couples first bus 2116 to a second bus 2120. In one embodiment, second bus 2120 includes a low pin count (LPC) bus. Various devices are coupled to second bus 2120 including, for example, a keyboard and/or mouse 2122, communication devices 2127 and a storage unit 2128 such as a disk drive or other mass storage device which often includes instructions/code and data 2130, in one embodiment. Further, an audio I/O 2124 is shown coupled to second bus 2120. Note that other architectures are possible, where the included components and interconnect architectures vary. For example, instead of the point-to-point architecture of FIG. 21, a system may implement a multi-drop bus or other such architecture. The system 2100 may be powered in any suitable manner, such as from an inverter, a battery, an AC power supply, a DC power supply, etc.

While aspects of the present disclosure have been described with respect to a limited number of embodiments, those skilled in the art will appreciate numerous modifications and variations therefrom. It is intended that the appended claims cover all such modifications and variations as fall within the true spirit and scope of this present disclosure.

A design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘to,’ ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1 's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the present disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

### EXAMPLES

Illustrative examples of the technologies disclosed herein are provided below. An embodiment of the technologies may include any one or more, and any combination of, the examples described below.

Example 1 includes a device comprising a circuit board; an inductor mounted on the circuit board, wherein the inductor comprises a first conductive strip extending along a length of the inductor; a second conductive strip extending parallel to the first conductive strip; and a bridging conductive strip connecting the first conductive strip and the second conductive strip; a first contact pad connected to the first conductive strip; a second contact pad connected to the second conductive strip; and a magnetic core adjacent the first conductive strip and the second conductive strip, wherein, in use, current passes from the circuit board to the first contact pad, from the first contact pad to the first conductive strip, from the first conductive strip to the bridging conductive strip, from the bridging conductive strip to the second conductive strip, from the second conductive strip to the second contact pad, and from the second contact pad to the circuit board.

Example 2 includes the subject matter of Example 1, and further including a voltage regulator, wherein the voltage regulator comprises the inductor.

Example 3 includes the subject matter of any of Examples 1 and 2, and wherein the voltage regulator is configured to have an input current of at least 25 amps.

Example 4 includes the subject matter of any of Examples 1-3, and wherein the circuit board comprises a high-speed signal trace, the high-speed signal trace positioned less than 5 millimeters from a nearest edge of the inductor.

Example 5 includes the subject matter of any of Examples 1-4, and wherein the high-speed signal trace is part of a peripheral component interconnect express (PCIe) interconnect.

Example 6 includes the subject matter of any of Examples 1-5, and wherein the high-speed signal trace is part of a compute express link (CXL) interconnect.

Example 7 includes the subject matter of any of Examples 1-6, and wherein the inductor comprises a first conductive riser strip connecting the first contact pad and the first conductive strip, and a second conductive riser strip connecting the second conductive strip and the second contact pad, wherein a current path through the inductor consists of the first contact pad, the first conductive riser strip, the first conductive strip, the bridging conductive strip, the second conductive strip, the second conductive riser strip, and the second contact pad.

Example 8 includes the subject matter of any of Examples 1-7, and wherein the magnetic core is a ferrite core.

Example 9 includes a system comprising the device of Example 1, further comprising a battery; a processor; a memory; and a display.

Example 10 includes an inductor comprising a conductor in a magnetic core, wherein the conductor follows a U-shaped meandering path.

Example 11 includes a voltage regulator comprising the inductor of Example 10.

Example 12 includes the subject matter of Example 11, and wherein the voltage regulator is configured to have an input current of at least 25 amps.

Example 13 includes a device comprising the inductor of Example 10, wherein the inductor is mounted on a circuit board, wherein the circuit board comprising a high-speed signal trace, the high-speed signal trace positioned less than 5 millimeters from a nearest edge of the inductor.

Example 14 includes the subject matter of Example 13, and wherein the high-speed signal trace is part of a peripheral component interconnect express (PCIe) interconnect.

Example 15 includes the subject matter of any of Examples 13 and 14, and wherein the high-speed signal trace is part of a compute express link (CXL) interconnect.

Example 16 includes the subject matter of any of Examples 13-15, and wherein the magnetic core is a ferrite core.

Example 17 includes a system comprising the inductor of Example 10, further comprising a battery; a processor; a memory; and a display.

Example 18 includes an inductor comprising a first conductive strip extending along a length of the inductor; a second conductive strip extending parallel to the first conductive strip; and a bridging conductive strip connecting the first conductive strip and the second conductive strip; a first contact pad connected to the first conductive strip; a second contact pad connected to the second conductive strip; and a magnetic core surrounding the first conductive strip and the second conductive strip, wherein, in use, current passes from to the first contact pad, from the first contact pad to the first conductive strip, from the first conductive strip to bridging conductive strip, from the bridging conductive strip to the second conductive strip, and from the second conductive strip to the second contact pad.

Example 19 includes a device comprising the inductor of Example 18, further comprising a voltage regulator, wherein the voltage regulator comprises the inductor.

Example 20 includes the subject matter of Example 19, and wherein the voltage regulator is configured to have an input current of at least 25 amps.

Example 21 includes a device comprising the inductor of Example 18, further comprising a circuit board, the circuit board comprising a high-speed signal trace, the high-speed signal trace positioned less than 5 millimeters from a nearest edge of the inductor.

Example 22 includes the subject matter of Example 21, and wherein the high-speed signal trace is part of a peripheral component interconnect express (PCIe) interconnect.

Example 23 includes the subject matter of any of Examples 21 and 22, and wherein the high-speed signal trace is part of a compute express link (CXL) interconnect.

Example 24 includes the subject matter of any of Examples 21-23, and wherein the inductor comprises a first conductive riser strip connecting the first contact pad and the first conductive strip, and a second conductive riser strip connecting the second conductive strip and the second contact pad, wherein a current path through the inductor consists of the first contact pad, the first conductive riser strip, the first conductive strip, the bridging conductive strip, the second conductive strip, the second conductive riser strip, and the second contact pad.

Example 25 includes the subject matter of any of Examples 21-24, and wherein the magnetic core is a ferrite core.

Example 26 includes a system comprising the inductor of Example 18, further comprising a battery; a processor; a memory; and a display.

1. A device comprising:
a circuit board;
an inductor mounted on the circuit board, wherein the inductor comprises:
a first conductive strip extending along a length of the inductor;
a second conductive strip extending parallel to the first conductive strip; and
a bridging conductive strip connecting the first conductive strip and the second conductive strip;
a first contact pad connected to the first conductive strip;
a second contact pad connected to the second conductive strip; and
a magnetic core adjacent the first conductive strip and the second conductive strip,
wherein, in use, current passes from the circuit board to the first contact pad, from the first contact pad to the first conductive strip, from the first conductive strip to the bridging conductive strip, from the bridging conductive strip to the second conductive strip, from the second conductive strip to the second contact pad, and from the second contact pad to the circuit board.

2. The device of claim 1, further comprising a voltage regulator, wherein the voltage regulator comprises the inductor.

3. The device of claim 2, wherein the voltage regulator is configured to have an input current of at least 25 amps.

4. The device of claim 1, wherein the circuit board comprises a high-speed signal trace, the high-speed signal trace positioned less than 5 millimeters from a nearest edge of the inductor.

5. The device of claim 4, wherein the high-speed signal trace is part of a peripheral component interconnect express (PCIe) interconnect.

6. The device of claim 4, wherein the high-speed signal trace is part of a compute express link (CXL) interconnect.

7. The device of claim 1, wherein the inductor comprises a first conductive riser strip connecting the first contact pad and the first conductive strip, and a second conductive riser strip connecting the second conductive strip and the second contact pad,
wherein a current path through the inductor consists of the first contact pad, the first conductive riser strip, the first conductive strip, the bridging conductive strip, the second conductive strip, the second conductive riser strip, and the second contact pad.

8. The device of claim 1, wherein the magnetic core is a ferrite core.

9. A system comprising the device of claim 1, further comprising:
a battery;
a processor;
a memory; and
a display.

10. An inductor comprising:
a bottom side to be mounted adjacent a circuit board;
a conductor in a magnetic core, wherein the conductor follows a U-shaped meandering path in a plane parallel to the bottom side.

11. A voltage regulator comprising the inductor of claim 10.

12. The voltage regulator of claim 11, wherein the voltage regulator is configured to have an input current of at least 25 amps.

13. A device comprising the inductor of claim 10, wherein the inductor is mounted on a circuit board, wherein the circuit board comprising a high-speed signal trace, the high-speed signal trace positioned less than 5 millimeters from a nearest edge of the inductor.

14. The device of claim 13, wherein the high-speed signal trace is part of a peripheral component interconnect express (PCIe) interconnect.

15. The device of claim 13, wherein the high-speed signal trace is part of a compute express link (CXL) interconnect.

16. An inductor comprising:
a first conductive strip extending along a length of the inductor;
a second conductive strip extending parallel to the first conductive strip; and
a bridging conductive strip connecting the first conductive strip and the second conductive strip;
a first contact pad connected to the first conductive strip;
a second contact pad connected to the second conductive strip;
a first conductive riser strip connecting the first contact pad and the first conductive strip;
a second conductive riser strip connecting the second conductive strip and the second contact pad, and
a magnetic core surrounding the first conductive strip and the second conductive strip.

17. A device comprising the inductor of claim 16, further comprising a voltage regulator, wherein the voltage regulator comprises the inductor.

18. The device of claim 17, wherein the voltage regulator is configured to have an input current of at least 25 amps.

19. A device comprising the inductor of claim 16, further comprising a circuit board, the circuit board comprising a high-speed signal trace, the high-speed signal trace positioned less than 5 millimeters from a nearest edge of the inductor.

20. The inductor of claim 16, wherein a current path through the inductor consists of the first contact pad, the first conductive riser strip, the first conductive strip, the bridging conductive strip, the second conductive strip, the second conductive riser strip, and the second contact pad.
